(19) United States
(12) Patent Application Publication
(10) Pub. No.: US 2007/0011085 A1
(43) Pub. Date: Jan. 11, 2007

(54) INTERACTIVE SIMULATOR FOR CALCULATING THE PAYOFF OF A HOME MORTGAGE WHILE PROVIDING A LINE OF CREDIT AND INTEGRATED DEPOSIT ACCOUNT

(76) Inventors: Christopher M. George, San Ramon, CA (US); Douglas A. Nesbit, San Ramon, CA (US)

Correspondence Address: GREENBERG TRAURIG LLP, 2450 COLORADO AVENUE, SUITE 400E, SANTA MONICA, CA, 90404, US

(21) Appl. No.: 11/381,331

(22) Filed: May 2, 2006

Related U.S. Application Data
(60) Provisional application No. 60/697,695, filed on Jul. 7, 2005.

(51) Int. Cl. G06Q 40/00

(52) U.S. Cl. 705/38

(57) ABSTRACT

A system and method for calculating and comparing the payoff time and interest costs of a mortgage loan and comparison loan by inputting financial information of a mortgagee, information about the amount and interest rates pertaining to the loans, calculating the payoff time of said loans, and the mortgage interest expense involved with the loans.

### RELATIONSHIP TO PRIOR APPLICATIONS

This application claims the benefit of and priority to U.S. Provisional Application Ser. No. 60/697,695, filed Jul. 7, 2005, the content of which is incorporated by reference herein in its entirety.

### BACKGROUND OF THE DISCLOSURE

1. Field of the Disclosure

The disclosure relates to a system and method for calculating the payoff time and interest expenses for a home mortgage while providing a line of credit.

2. General Background

In a companion application entitled “Home Ownership Payment System and Method,” commonly assigned and filed simultaneously with this application, a system is disclosed for accelerating mortgage payments and payoff on a home mortgage and simultaneously providing a line of credit together with an integrated deposit account for the mortgagee. The teachings in the application on “Home Ownership Payment System and Method” are incorporated herein by reference.

Specifically because the interest costs and payoff time of said “Home Ownership Payment System and Method” are dependent, in part, on the amount of funds deposited and withdrawn, there is a need in such a system for a system and method that models the mortgage loan, using the mortgagee's own financial information, to compute loan payoff time and interest expenses for the mortgagee to determine the amount of interest that would be paid by the mortgagee until the mortgage is paid off.

### SUMMARY

It is an object of this invention to provide a system for computing payoff time and interest expenses on a home mortgage loan.

It is a further object of this invention to compare the foregoing calculations to the mortgagee's existing mortgage and provide a selection of several other comparison loans that may be chosen.

It is still further an object of this invention to provide for advanced modeling of a mortgage loan based on unlimited personal spending assumptions and interest rate trend assumptions. These and other objects are accomplished by providing a system and method for calculating the payoff time of a mortgage loan by inputting financial information of a mortgagee and the amount of the mortgagee's mortgage loan, calculating the payoff time of said loan, and the mortgage interest expense involved with the loan.

### BRIEF DESCRIPTION OF THE DRAWINGS

FIG. 1 is a first illustrative screen accessing the entry into the simulator program disclosed herein;

FIG. 2 is a subsequent screen used to initiate the program;

FIG. 2A is a screen where terms, disclaimers, and privacy statements are made and agreed to by the user.

FIG. 3 is the first input screen, where the mortgagee can input their various incomes, which will be assumed to represent deposits to reduce the outstanding principal balance of the new line of credit once established, and where the mortgagee can specify the frequency of said deposits to the line of credit;

FIG. 3A illustrates how one can select the frequency of deposits to the line of credit;

FIG. 4 is the second input screen, for inputting the characteristics associated with one's various debts, and where the mortgagee can select which of these debts will be financed by the new line of credit;

FIG. 4A illustrates how one can specify which of the debts on the second input screen will be financed by the new line of credit;

FIG. 5 is a third input screen, for capturing information on the mortgagee's current living expenses by determining how much of one's net income remains after housing and all other expenses, the results of which will be assumed to represent withdrawals from the line of credit, increasing it's balance, once established;

FIGS. 5A through 5E illustrate how one can also manually input one's current living expenses in a detailed fashion by type and frequency of spending;

FIG. 6 is a fourth input screen where future interest rate trend assumptions can be selected, and where the mortgagee can select a conventional loan against which the results will be compared;

FIG. 6A illustrates how one can select one of several preset interest rate trend assumptions;

FIG. 6B illustrates how one can select one of several conventional loans against which the results of the loan program suggested herein will be compared;

FIG. 6C illustrates how one can select one of several preset interest rate trend assumptions which will apply to the comparison loan selected in FIG. 6B.

FIG. 6D shows an input table that is made available when the Manual Rate Trend box in FIG. 6 is checked; this input table allows for unlimited modeling of future interest rate assumptions which will apply to either the loan program suggested herein or the comparison loan selected in FIG. 6B, or both;

FIG. 7 is a fifth input screen where the mortgagee can modify key loan characteristics of the loan program suggested herein, and where the mortgagee can modify key loan characteristics of the conventional comparison loan;

FIG. 8 is a sixth input screen where the mortgagee can modify the computation to simulate the effects of making additional payments to the loan program suggested herein and to the selected comparison loan;

FIG. 9 is a seventh input screen where the mortgagee can modify the computation to simulate the effects of making additional withdrawals from the loan program suggested herein;

FIG. 10 is a graphical illustration of the final computed results showing how the loan proposed herein can be paid off in 10.5 years with the information provided by the mortgagee in FIGS. 3 to 9, and showing how the loan proposed herein compares to the selected comparison loan, and including the computation of a 30-year mortgage rate which is equivalent to the amount of interest charged by the loan program suggested herein;

### DESCRIPTION OF THE PREFERRED EMBODIMENT

The invention contemplates the utilization of a website or CD ROM or the like where a potential or present homeowner can input his or her financial information and determine payoff time and interest expenses for the mortgage loan proposed herein. The system disclosed herein will show the mortgagee how long it will take to pay off the loan program proposed herein, and the amount of interest that will be charged over the life of the loan. By comparing these results to the results also provided for the selected comparison loan, the mortgagee will be able to see how much interest will be saved. Additionally, the system disclosed herein will show the mortgagee the 30-year mortgage rate which is equivalent to the amount of interest charged by the loan program suggested herein;

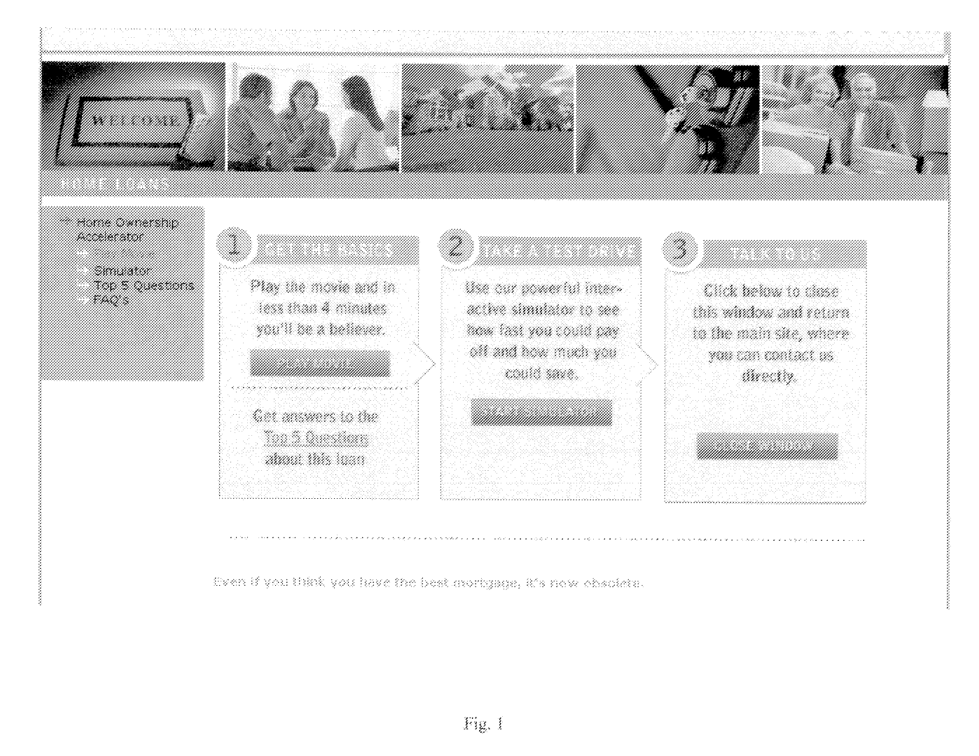

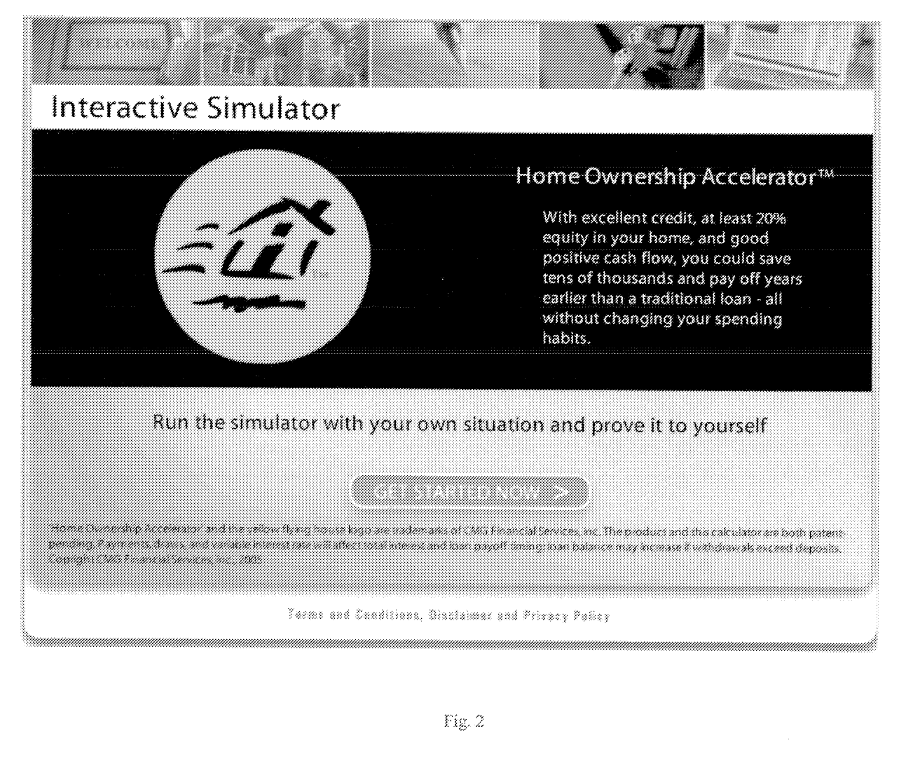

The system and method disclosed herein can be carried out by accessing a series of sequential printouts as illustrated in FIGS. 1 to 10.

These printouts may be provided on a website, in printed form, or through suitable electronic data transfer means, such as a CD ROM or DVD.

FIG. 1 may be the opening, or start page, which indicates that one can start the Simulator.

This opening page may have a brief description of the program. For example, HOW IT WORKS may be one heading.

Bank your money in your mortgage. With the Home Ownership Payment program described herein, you direct-deposit your entire paycheck into your mortgage, instead of your checking account. This immediately reduces your principal balance. Since interest is based on your daily balance, you start saving interest immediately compared to traditional loans!

Access your funds just like you used to. You pay all of your expenses out of your account, just like you would with a traditional bank account—using the unlimited checks, free ATM/Debit card, and free online bill-pay that comes with the account. Until you need the money, though, it's in your mortgage in the form of a lower principal balance, saving you 5-6% in mortgage interest, instead of earning 1% in a bank account. Less interest means that more of your take-home pay goes towards principal, and you pay off sooner. With no change to spending habits!

A second heading might be: HOW EFFECTIVE IS IT?

If you're an average borrower with good cash flow, you could pay off an average sized loan in as little as half the time—with no changes to spending habits.

Let's look at an example:

Imagine you have net pay of $100,000 annually, saving 15% of your net income after expenses, and you have a $400,000 30-year fixed-rate mortgage at 5.5%. And, let's even assume that mortgage interest rates are climbing on a “reverse course” that mirrors their recent decline (APR 8.19%)! A ‘worst case rate scenario!”

Saves interest, pays off sooner.

In this example, refinancing to the Home Ownership Payment program roughly doubles your mortgage efficiency. You could pay off in as little as 17.3 years and save nearly $89,000 (21%) in interest, compared to the 30-year fixed rate loan at 5.5%. In fact, to save that much interest, you'd have to find a 30-year mortgage at 4.4%, which is very unlikely.

But what if rates go up even more?

In this example, the adjustable rate on the Home Ownership Payment program would have to average 9.6% over the entire 17.3 years for the interest payments to equal that of the 30-year fixed rate mortgage at 5.5%. That's not likely to happen either.

Seeing is believing. Try it for yourself.

The Interactive Simulator disclosed herein shows one how the Home Ownership Payment program can help them to achieve financial freedom sooner.

A brief description of the Program is a follows:

Specifications.
Loan type: Adjustable rate line of credit, based on 1-month LIBOR index.
Adjustment period: monthly
Term: 30 years
Lifetime cap: 5% over start rate
Minimum credit line: $100,000
Maximum credit line: $2,500,000
Minimum down payment: as low as 20%
Minimum credit scores: 680 (excellent credit)
Withdrawals: ATM/Visa P.O.S. card with 8 surcharge-free ATM transactions per month at any ATM, checks, bill-pay, ACH (automated clearing house transfers), EFT (electronic funds transfer).
Payments: Direct payroll deposit (required), ACH, EFT, Fed Wire, Bank by mail.
Statements: Monthly. Online account access.

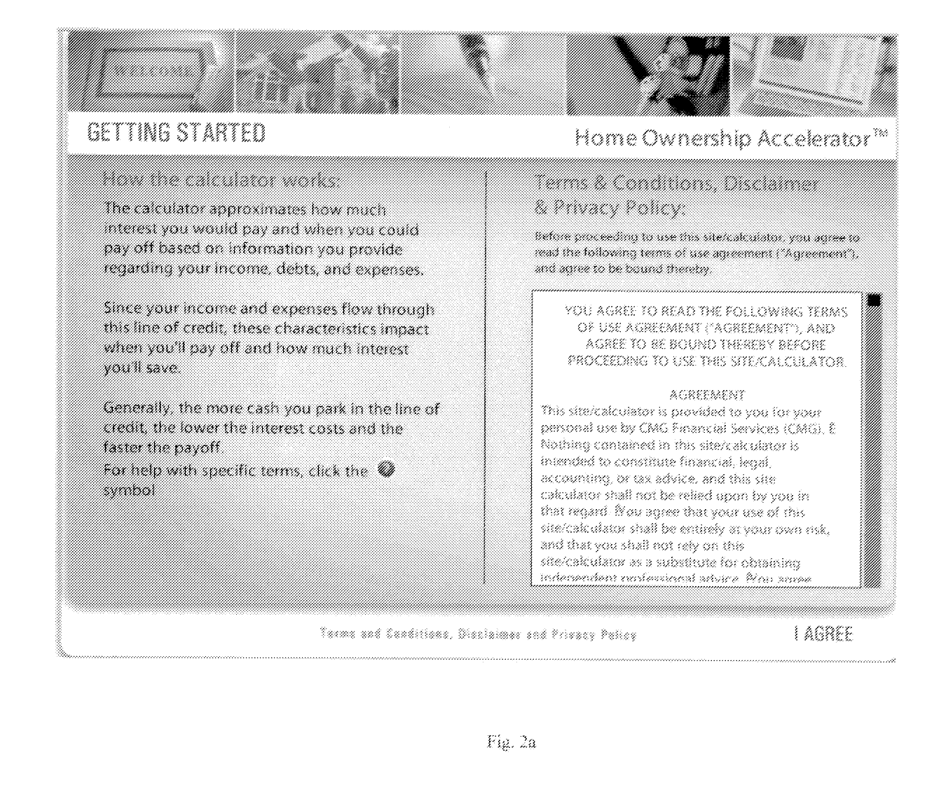

FIG. 2 illustrates the Getting Started page. It may include a brief statement, such as:
CMG Home Ownership Payment Program
With excellent credit, at least 20% equity in your home, and good positive cash flow, you could save tens of thousands and pay off years earlier than a traditional loan—all without changing your spending habits.

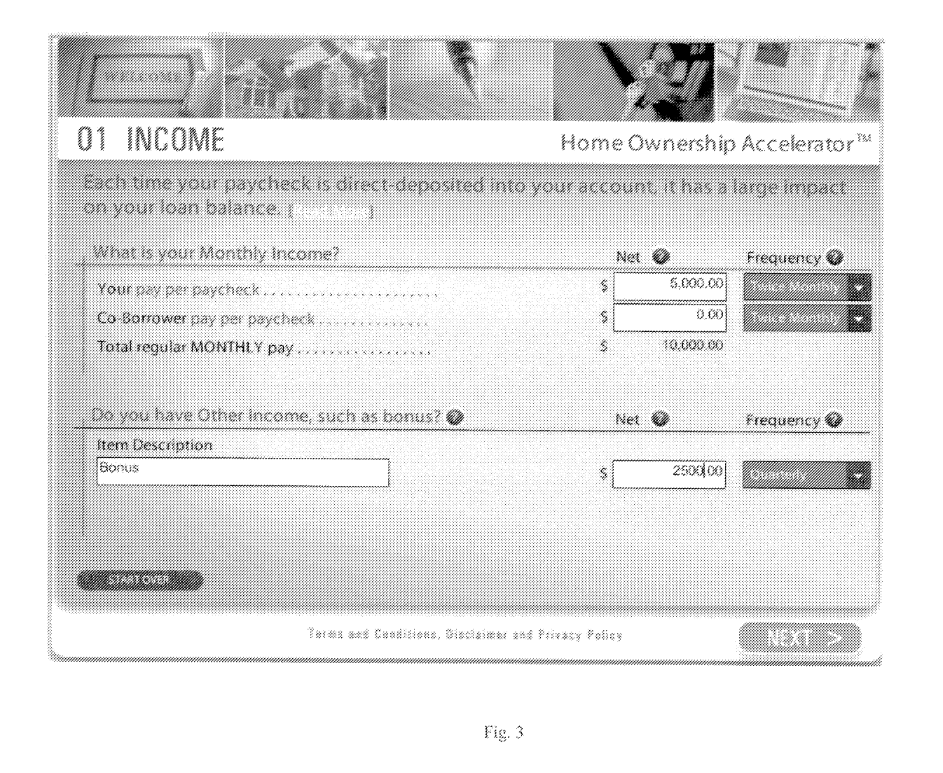

FIG. 3, the next screen, may provide a brief description of how the calculations work and, if desired, any suitable terms and conditions, disclaimers, etc. For example, this screen may indicate that:
The calculator approximates how much interest one would pay and when one could pay it off based on information provided regarding one's income, debts, and expenses.
Since one's income and expenses flow through the mortgage, these characteristics impact when one would pay off the loan and how much interest will be saved.
Generally, the more cash in the mortgage, the lower the interest costs and the faster the payoff.

FIG. 3 illustrates the Income screen. This screen may have a brief description of what is to be inputted. For example, the user or users (a co-borrower, for example) input information about their income. The amount and timing of income affects the loan payoff and overall interest cost, since all income and expenses flow through the loan (line of credit). So capturing this information here is essential to the computation. Gathering data on variable timing of income streams is unique in the world of mortgage calculators.

The question marks or Read More may provide answers to the mortgage's questions when checked, as is true in all screens in the figures herein.

FIG. 3 has been filled in to show a net income of $5,000 occurring twice a month. There is also a quarterly bonus of $2,500 (net of $6,000). Income from a co-borrower is shown as $0 in this example, but may be filled in just like the primary borrower. The frequency of payment may be changed by clicking on the down arrow (once or twice a month, for example). The frequency of the bonus can also be varied by clicking on the appropriate down arrow (e.g., quarterly, monthly or annually).

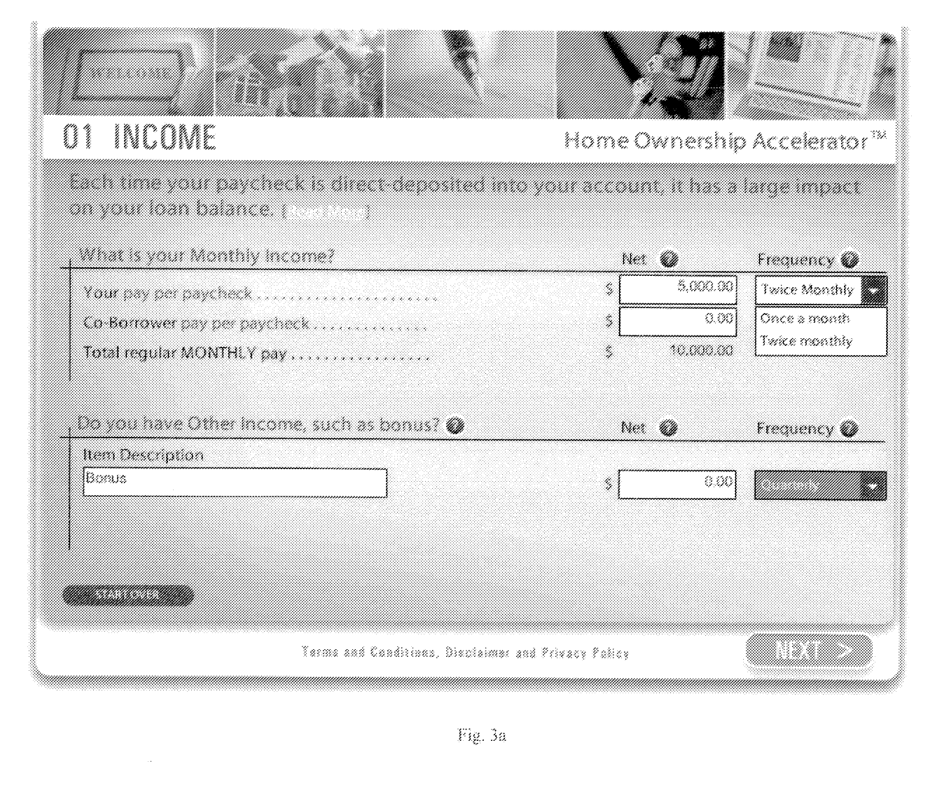

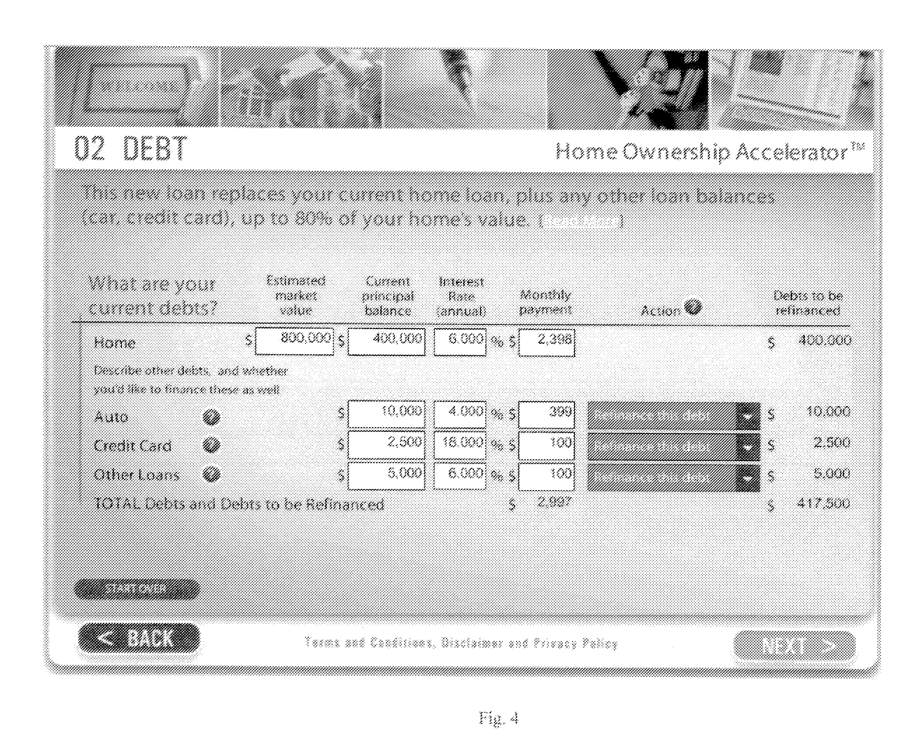

FIG. 4 illustrates an arbitrary debt entry screen. Again, appropriate directions or instructions may be provided. For example, the information shown may indicate that the users input information about their various debts. Since the program in which these calculations may be used may replace (refinance) their home debt and any other debts they wish, it is essential to capture this information here. It is used in the computation.

Thus, in the example given, a home mortgage of $400,000 is shown on a $880,000 home, and the homeowner's existing 6.0% mortgage (old mortgage) payment is $2,398. Home and Credit Card loans are also listed, along with the annual interest rate and monthly payments. As seen, the debt to be financed is listed at $417,500, the user having the option to refinance the debts or leave them as-is, by clicking on the appropriate down arrows. These selections are essential to capture as they affect the computations.

FIG. 4A illustrates how one can specify which of the debts on the second input screen in FIG. 4 will be financed by the new line of credit.

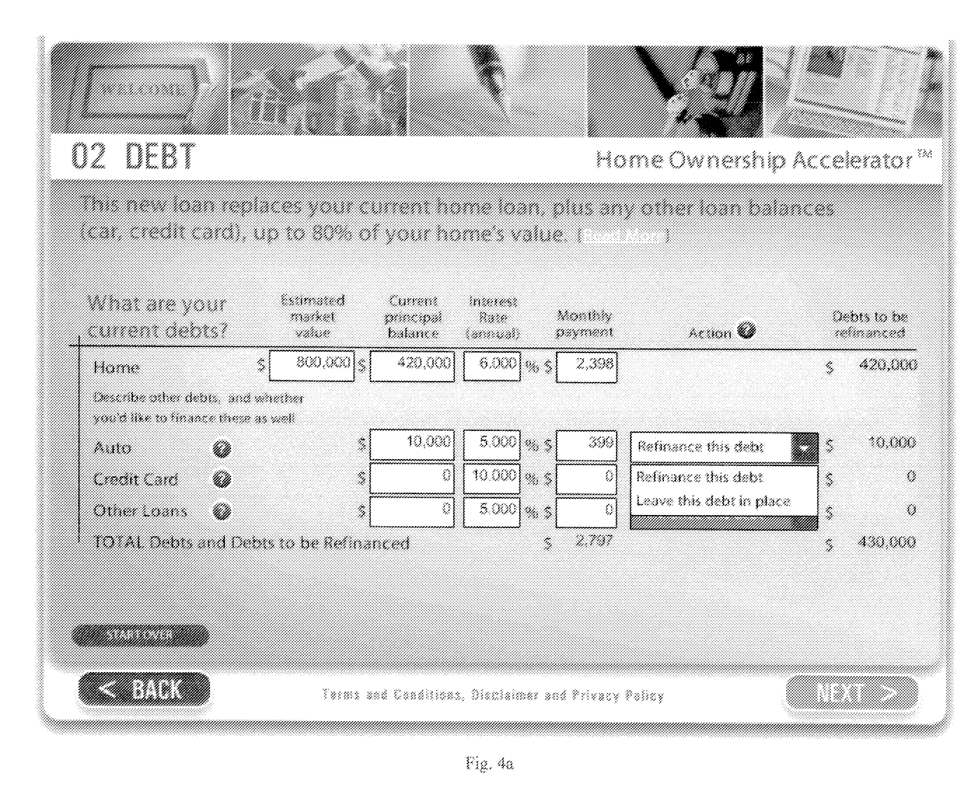

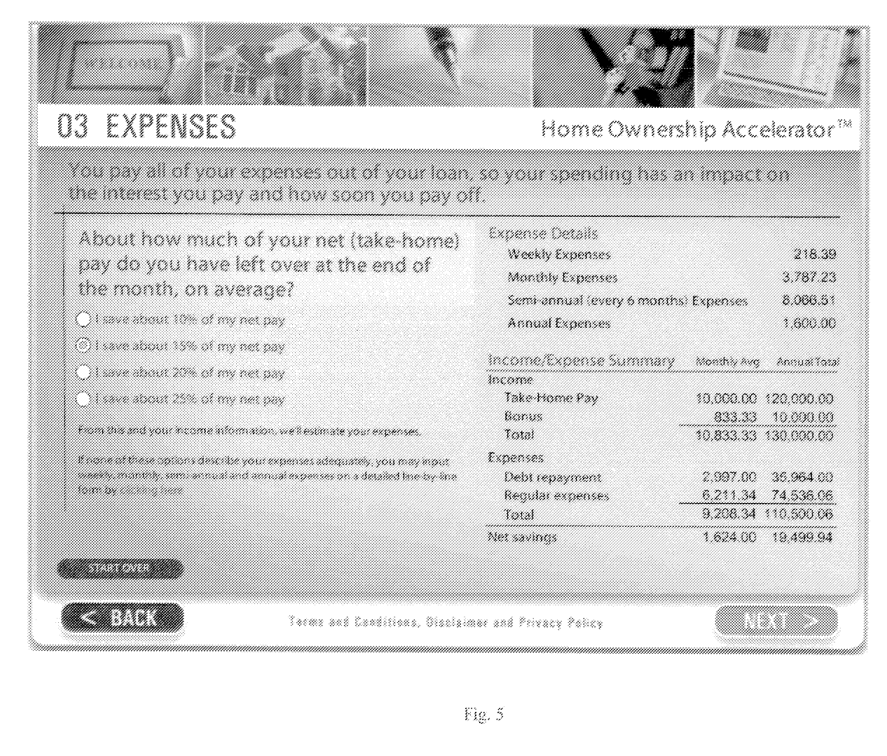

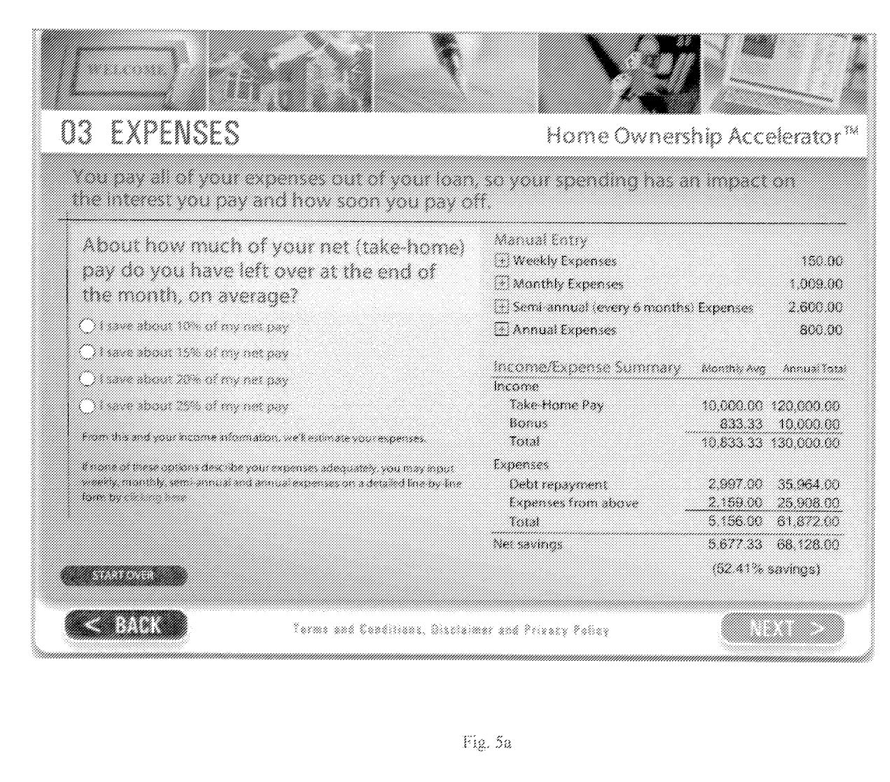

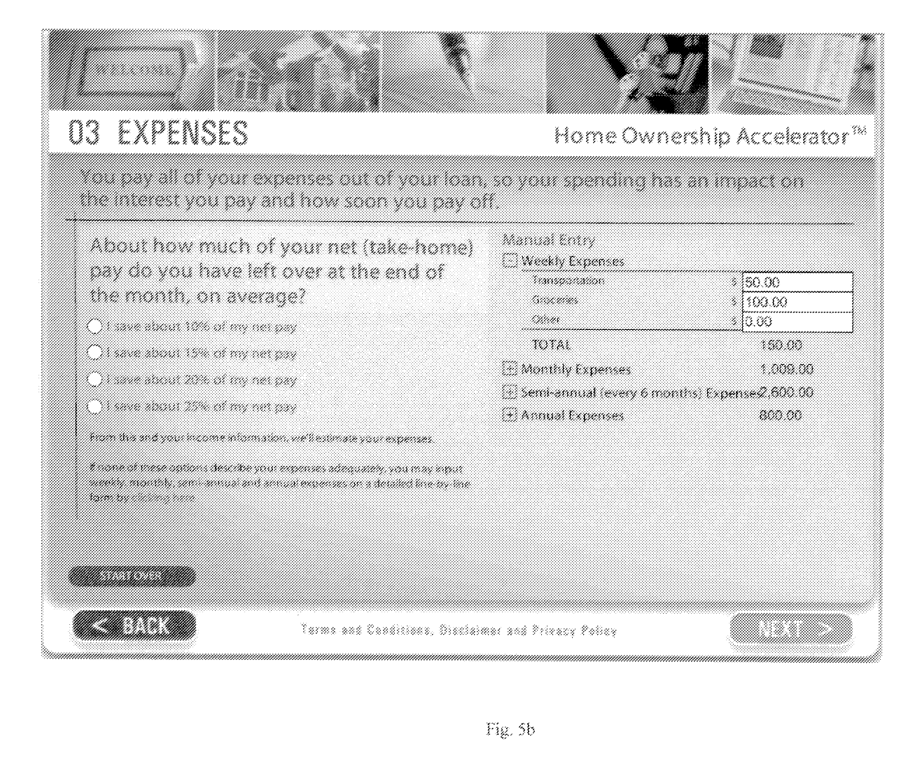

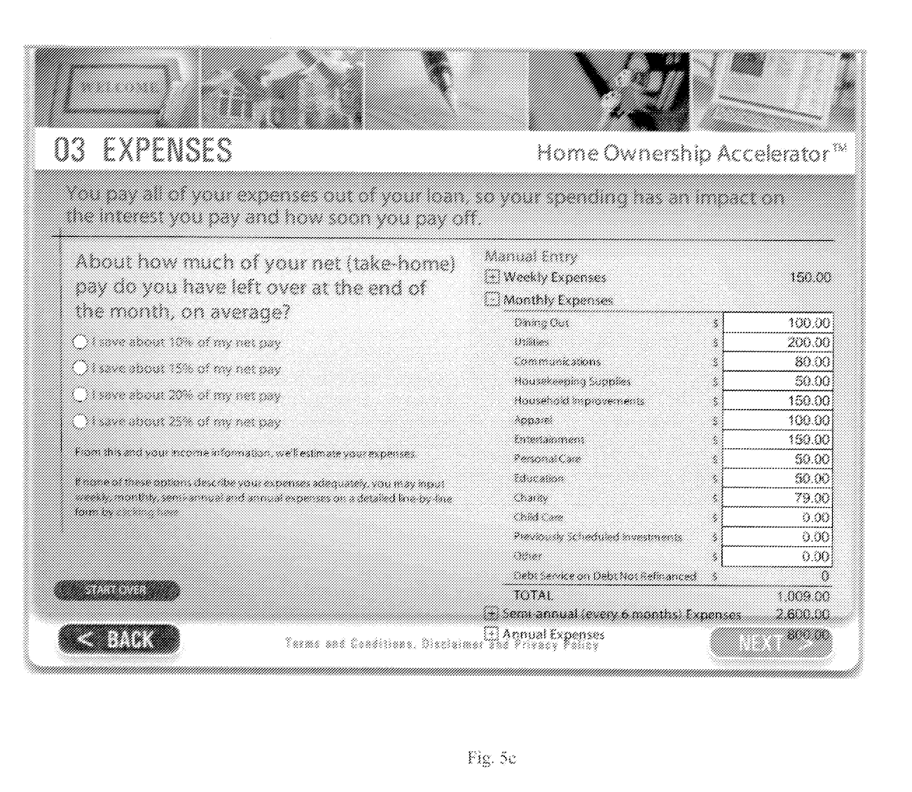

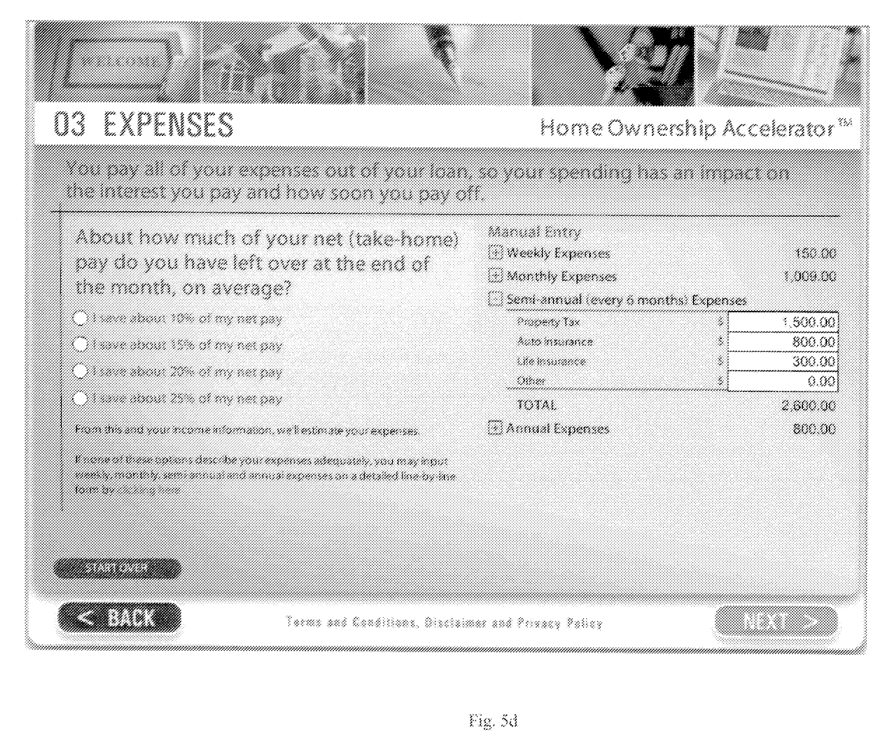

FIG. 5 illustrates the manner in which information about the homeowner's non-mortgage expenses are captured. Since many people do not keep a monthly budget, it is essential to understand how much of their net income is left over after said expenses and existing mortgage payments. The user selects the option closest to their own situation, and the calculator estimates their expenses, and illustrates a summary monthly budget. In the example given, the mortgage holder saves about 15% of their net pay each month. This approach to estimating expenses is unique among mortgage calculators.

FIGS. 5A through 5E illustrate how one can also manually input one's current living expenses in a detailed fashion by type and frequency of spending.

If the mortgagee has a detailed monthly budget they would like to enter, and would not like to estimate expenses, by clicking on Click Here, the mortgagee can input weekly, semi-annually or annual expenses on a detailed line-by-line schedule (the Expenses Details changes to Manual Entries and, by clicking on the appropriate expense, a line-by-line schedule for entering expenses is presented). This feature is unique among mortgage calculators.

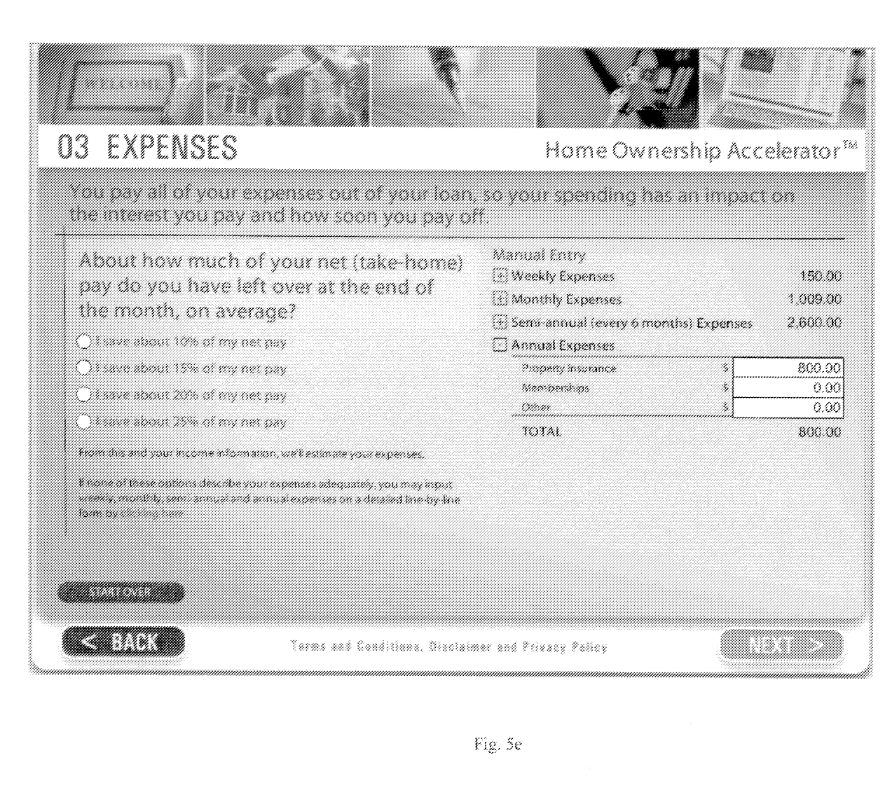

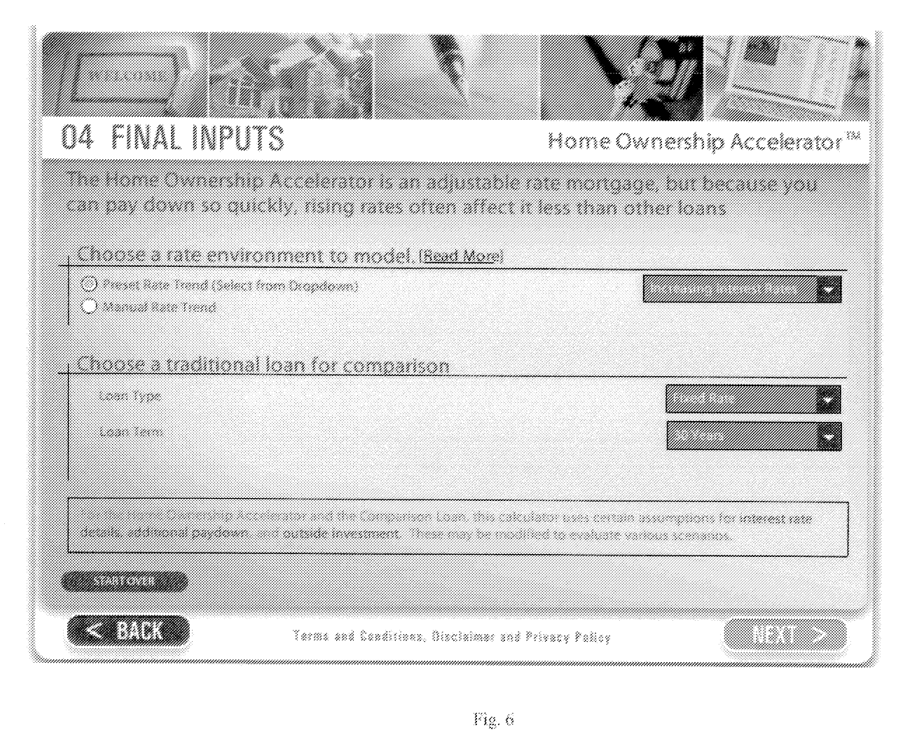

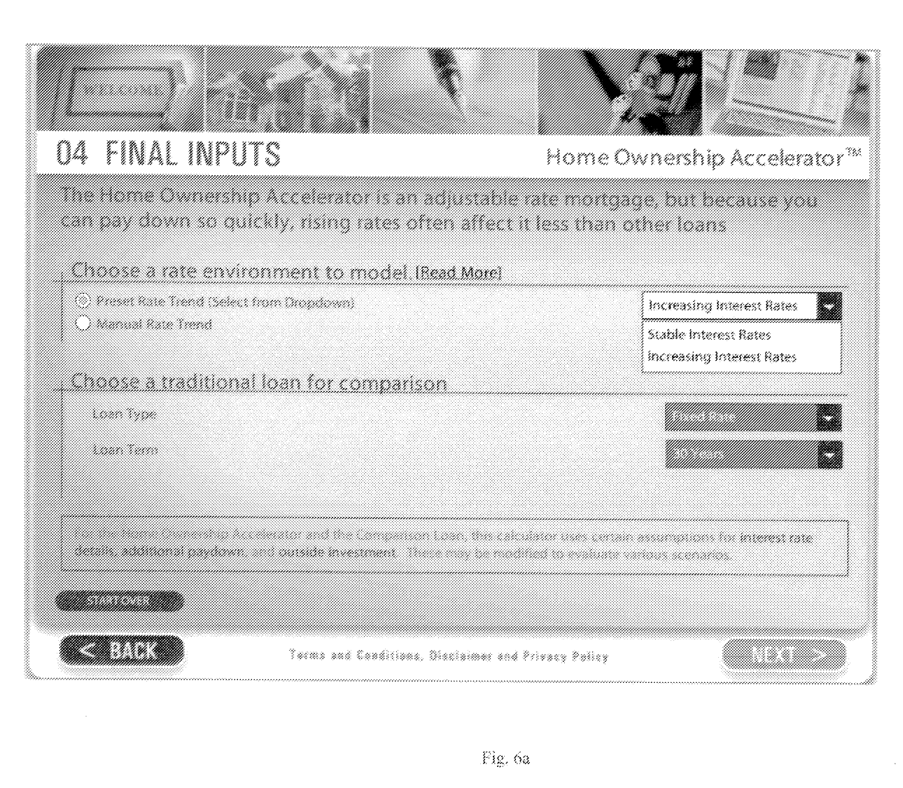

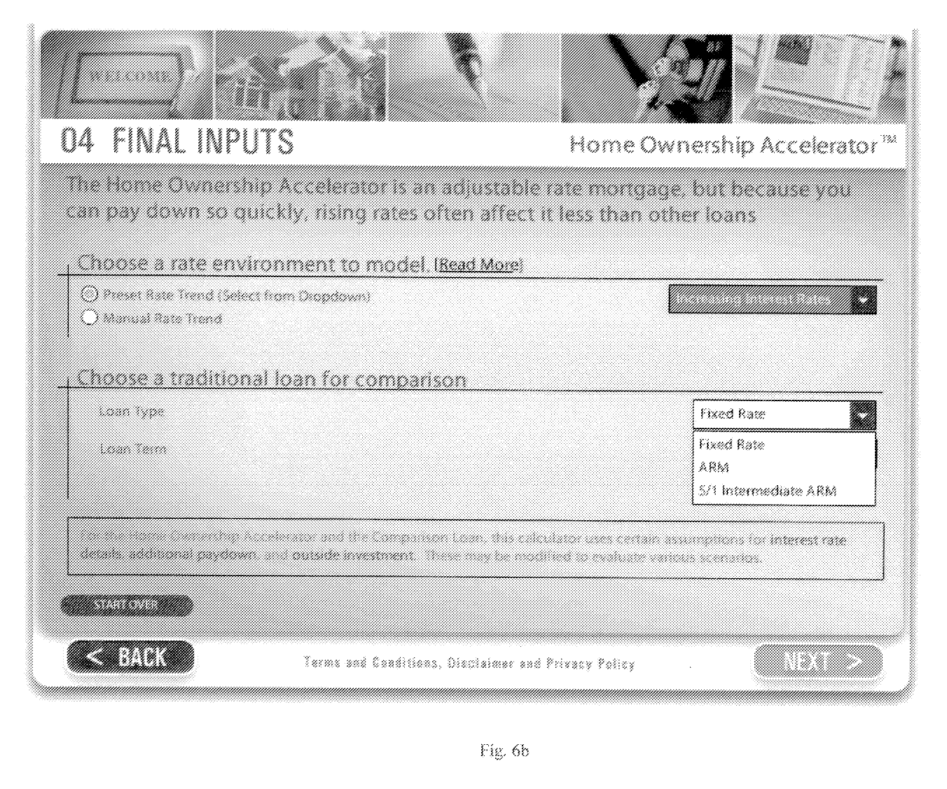

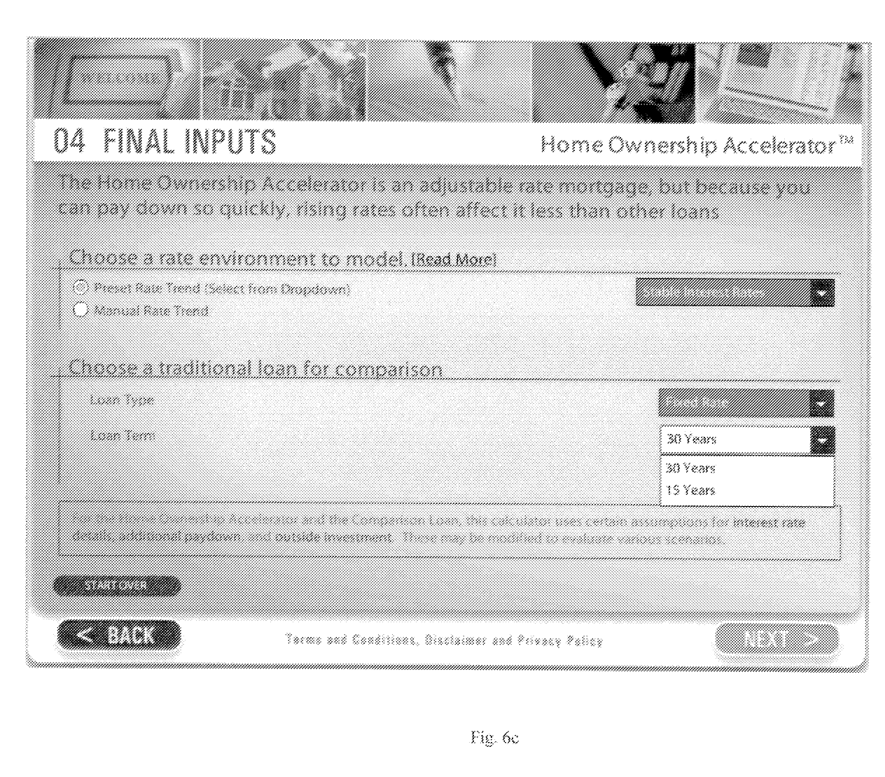

FIG. 6 shows a screen where the user may select the desired preset rate trend used in the calculations and where the user may select a comparison loan and comparison loan rate trend to be used in the calculations. These features are unique among mortgage calculators.

FIG. 6A illustrates how one can select one of several preset interest rate trend assumptions.

FIG. 6B illustrates how one can select one of several conventional loans against which the results of the loan program suggested herein will be compared.

FIG. 6C illustrates how one can select one of several preset interest rate trend assumptions which will apply to the comparison loan selected in FIG. 6B.

FIG. 6D illustrates a table generated when the Manual Rate Trend box in FIG. 6 is checked. This entry schedule is essential for modeling unlimited rate trend assumptions, and is unique among mortgage calculators.

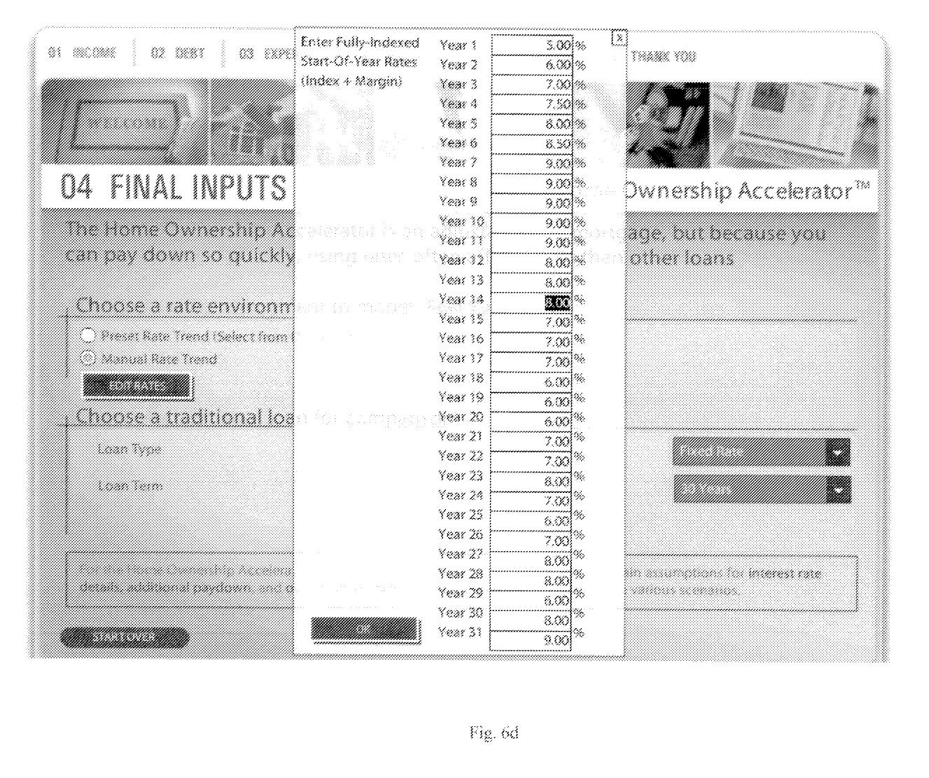

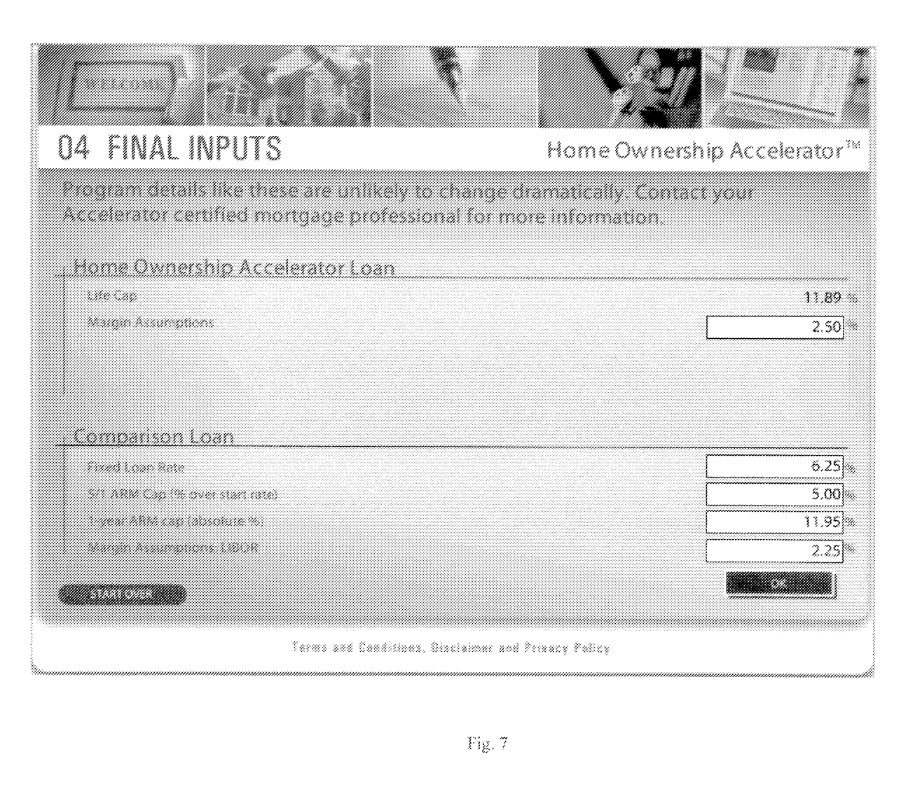

FIG. 7 is a screen where the user may enter key assumptions about the loan margin, and assumptions about the comparison loan. All of these are key factors in the calculation of the results.

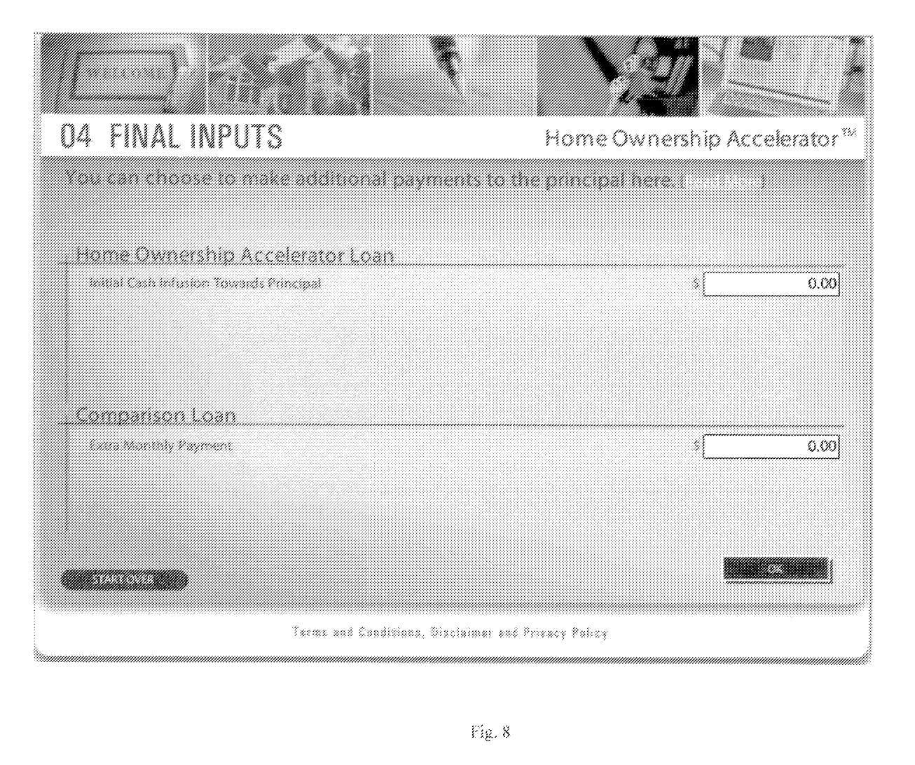

FIG. 8 is a screen where the user may enter an assumption about an initial cash infusion towards the principal balance of the suggested loan; this feature is unique in the world of mortgage calculators. In this screen, they can also enter information about potential extra payments towards the principal balance of the comparison loans.

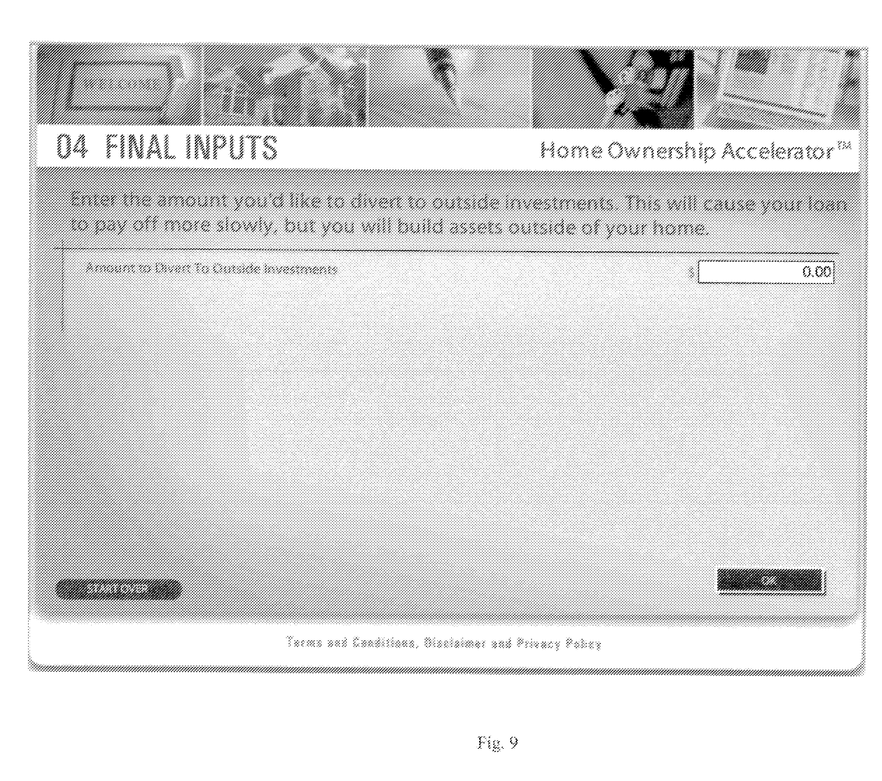

FIG. 9 is a screen where the user may enter information which allows them to model the effect of withdrawing an extra monthly amount out of the suggested loan, for outside investment or expenditures. This feature is unique in the world of mortgage calculators.

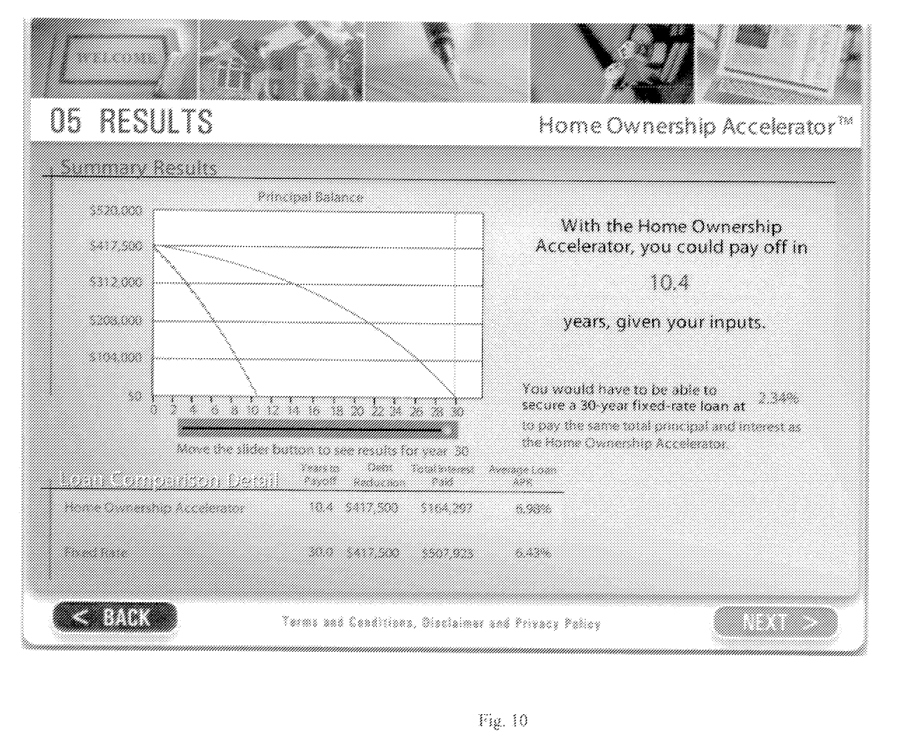

FIG. 10 is a graphical depiction showing how the loan example may be paid off in 10.4 years as compared with a 30-year fixed-rate loan. The computation also illustrates how the homeowner would have to secure a 30-year fixed rate loan at the rate of 2.34% to pay as little interest as with the loan suggested herein. This computation is unique in the world of mortgage calculators.

There is thus disclosed a calculator for calculating payoff time and interest expenses for a home mortgage. This information may be used in a program providing for a line of credit and an integrated deposit account to the mortgagee as disclosed in the application entitled “Home Ownership Payment System and Method,” concurrently filed with this application.

Although a particular embodiment of the invention is disclosed, variations thereof may occur to an artisan and the scope of the invention should only be limited by the scope of the appended claims.

We claim:

1. A system for calculating the payoff time of a mortgage loan and indicating to the mortgagee how fast the loan may be paid off while generating a line of credit and integrated deposit account in a mortgage payment program for the mortgage comprising:
an income input screen having means thereon for inputting the income of said mortgagee;
a debt screen having means thereon for inputting the amount of loan debt of various types for said mortgagee;
an input screen having means thereon for inputting the expenses of said mortgagee; and
an input screen having means thereon for selecting the expected future interest rate trend and comparison loans and their expected future interest rate trends;
a results screen presenting the computed results based on the information inputted to display the interest costs of said mortgage as compared to the selected comparison loan over a predetermined period of time, and paydown timing of said mortgage and comparison loan after paying debt and expenses owed by said mortgagee over said predetermined period of time of said program.

2. The system of claim 1 wherein said income screen has means thereon for entering any bonuses received by said mortgagee.

3. The system of claim 1 wherein said income screen has means thereon for entering a co-borrower's income therein.

4. The system of claim 1 wherein said debt screen includes means therein for inputting various debts to be financed by said mortgagee other than said mortgage loan, and whether to assume that certain of these debts are to be re-financed by said mortgage.

5. The system of claim 1 wherein said input screen combining said debt and income includes means for varying the amount of expenses displayed depending on the percent of net take-home pay of said mortgagee left over each month after payment of all debts and expenses by said mortgagee.

6. The system of claim 1, including a loan comparison screen for comparing the loan paydown timing and interest calculation of said mortgage loan with that of a selected comparison loan and including the presentation of results which show the equivalent 30-year mortgage rate which has the same interest costs as said mortgage loan.

7. The system of claim 6 wherein said loan comparison screen includes means for varying the interest rates of said loans.

8. The system of claim 1, including a screen presenting a graphical depiction of the time of payoff of said mortgage loan and comparing said time of payoff with the time of payoff of a selected comparison loan

9. The system of claim 1, including a screen graphically illustrating when the mortgagee's conventional loan would be paid off.

10. The system of claim 1, including a screen allowing the mortgagee to choose differing interest rates to compare a conventional loan to said program.

11. The system of claim 1, including a screen for allowing the mortgagee to view differing results when modifying key loan characteristics of the loan in said program and in loans compared with the loan in said program.

12. The system of claim 1, including a screen for comparing the loan of said program with differing loans.

13. The system of claim 12, wherein said differing loans may be at either a fixed rate, an adjustable rate or a hybrid adjustable rate.

14. The system of claim 1, including a screen illustrating to the mortgagee the effect of making accelerated payments to the loan in said loan program.

15. The system of claim 1, including a screen for illustrating to the mortgagee what occurs if the interest rate on outside investments of the mortgagee is adjusted and funds are diverted from said program to said outside investments.

16. A method for calculating the payoff time of a mortgage loan and indicating to the mortgagee how fast the loan may be paid off while generating a line of credit and an integrated deposit account in a mortgage payment program for the mortgage comprising the steps of:
inputting the income of said mortgagee;
inputting the amount of loan debt of said mortgagee;
inputting the expenses of said mortgagee;
inputting the desired interest rate trend assumptions; and
combining the information inputted to display the interest savings on said mortgage over a predetermined period of time, and paydown of said mortgage after paying debt and expenses owed by said mortgagee over said predetermined period of time of said program.

17. The method of claim 16 including the step of entering any bonuses received by said mortgagee into said program.

18. The method of claim 16 including the step of entering a co-borrower's income into said program.

19. The method of claim 16 including the step of inputting debts to be financed by said mortgagee other than said mortgage loan into said program.

20. The method of claim 16 wherein the step of combining said debt and income includes the step of varying the amount of savings displayed depending on the percent of net take-home pay of said mortgagee left over each month after payment of all debts and expenses by said mortgagee.

21. The method of claim 16, including the step of comparing the loan paydown and interest calculation with other loans in said program.

22. The method of claim 21 wherein the step of comparing the loan paydown and savings with other loans includes the step of varying the interest rates of said other loans.

23. The method of claim 16, including the step of presenting a graphical depiction of the time of payoff of said mortgage loan and comparing said time of payoff with the time of payoff of a selected comparison loan, including the presentation of results which show the equivalent 30-year mortgage rate which has the same interest costs as said mortgage loan.

24. The method of claim 16, including the step of graphically illustrating when the mortgagee's selected comparison loan would be paid off.

25. The method of claim 16, including the step of allowing the mortgagee to choose differing interest rates to compare a comparison loan in said program.

26. The method of claim 16, including the step of allowing the mortgagee to view differing results when modifying key loan characteristics of the loan in said program and in loans compared with the loan in said program.

27. The method of claim 16, including the step of comparing the loan of said program with differing loans.

28. The method of claim 27, wherein the step of comparing the includes the step of comparing said loan with differing loans at either a fixed rate, an adjustable rate or a hybrid adjustable rate.

29. The method of claim 16, including the step of illustrating to the mortgagee the effect of making accelerated payments to the loan in said loan program.

30. The method of claim 16, including the step of illustrating to the mortgagee what occurs if the interest rate on outside investments of the mortgagee is adjusted and funds are diverted from said program to said outside investments.
